(19) United States
(12) Patent Application Publication
(10) Pub. No.: US 2025/0087379 A1
(43) Pub. Date: Mar. 13, 2025

(54) METHOD OF TREATING BORATE WASTE LIQUID

(71) Applicant: Eion International, Ltd., Taoyuan City (TW)

(72) Inventor: Ching-Tsuen Huang, Taoyuan City (TW)

(21) Appl. No.: 18/692,342

(22) PCT Filed: Sep. 17, 2021
(86) PCT No.: PCT/CN2021/119024

§ 371 Date: Nov. 15, 2024

(51) Int. Cl. G21F 9/16

(52) U.S. Cl. CPC G21F 9/165

(57) ABSTRACT

A method of treating a liquid borate waste includes the following steps: modulating a raw liquid borate waste; concentrating the liquid borate waste to make a high-concentration liquid polyborate waste; performing granulation of the high-concentration liquid polyborate waste with a granulating agent and preparing solid borate granules; and making the solid borate granules into a monolithic waste form with good performance.

### FIELD OF THE INVENTION

The disclosure relates to a method of treating a liquid borate waste, and in particular to a method of treating a radioactive liquid borate waste.

### BACKGROUND OF THE INVENTION

Natural boron contains about 80% of boron-11 and about 20% of boron-10. Boron-10 is a good neutron absorber. Therefore, in a pressurized water reactor (PWR), boric acid is used as a neutron absorber in cooling water of the nuclear reactor to adjust the neutron (number) density of the cooling water. In addition, boric acid is also added to the water of a used nuclear fuel storage pool to adjust the neutron (number) density of the pool water. When these boric acid solutions are discarded at the end of use, an alkaline solution (such sodium hydroxide) is added for neutralization to obtain a radioactive liquid waste containing sodium borate, which is hereinafter referred to as the liquid borate waste. The radioactive liquid borate waste must be solidified and turned into a solid waste form with the quality meeting the safety requirements for final disposal, so that it is isolated from the living area of humans, thereby avoiding its radioactive hazards to humans or the environment. The term “final disposal” here is a special term for radioactive waste management, which refers to the construction of facilities with multiple engineering barriers at qualified geology for permanent isolation and burial of radioactive waste.

Traditional solidification methods for radioactive liquid borate waste include cement solidification process, polymer resin solidification process, and asphalt solidification process. However, due to the poor compatibility of organic solidifying agents such as polymer resin and asphalt with the inorganic salts of liquid waste, the solid waste form produced by solidification will undergo salt out phenomenon, and the polymer resin and the asphalt will undergo biodeterioration, the polymer resin solidification process and the asphalt solidification process are not applicable to the solidification of inorganic salt liquid wastes.

The cement solidification process, which uses cement and pozzolanic materials as solidifying agents, can not only solidify the liquid waste through the hydration reaction, but also make inorganic salts form hard solids. However, in the case where the liquid borate waste is solidified by the cement solidification process, when the boron concentration is high (for example, the boron concentration is higher than 2 wt %), apparent solidification retardation will occur, since the hydration reaction of the cement will be retarded due to the hard calcium borate film formed on the surface of the cement granules. Therefore, traditionally, the cement solidification of the liquid borate waste is performed at a low boron concentration, or before the cement is added for solidification, adding slaked lime for pretreatment to alleviate the solidification retardation. In other examples, such as U.S. Pat. Nos. 4,293,437, 4,210,619, 4,800,042, 4,906,408 and 4,620,947, and Chinese patents No. 102800377A and No. 102254579B, an alkaline precipitant is added to convert sodium borate with high water solubility into a borate precipitate with low water solubility before cement or asphalt is added for solidification, so as to alleviate the solidification retardation. However, since (1) the alkaline precipitant added greatly increases the quantity of the cement waste form produced and (2) a large amount of cement solidifying agent is still needed during the solidification of the liquid waste, the volume of the cement waste form produced is greatly increased. Moreover, the cost of the radioactive waste management is very high, and the final disposal site is hard to find, so it is not economical to treat the liquid borate waste by the traditional cement solidification process.

In order to reduce the volume of the cement solidified waste form and increase its boron content, JGC Corporation in Japan has developed a so-called advanced cement solidification process. In this process, lime is added to the liquid borate waste at 40° C. to 60° C. and stirred for about 10 h such that the borate (usually in the form of sodium salt) is converted into a more stable calcium borate precipitate, and the precipitate is obtained by filtration, dehydrated, and solidified with a cement solidifying agent. However, this process is complex in operation and produces secondary waste containing sodium hydroxide, which requires additional treatment.

In addition, U.S. Pat. No. 5,457,262 performs cement solidification after the liquid borate is converted into a liquid polyborate with high polymerization degree, so that no secondary waste is produced and the boron loading rate of the waste form produced can be increased. However, the cement solidified waste form produced by this process has low water immersion resistance, making the application of this process limited in cases where water immersion resistance of the waste form is strictly required.

### SUMMARY OF THE INVENTION

The disclosure provides a method of treating a liquid borate waste, which can avoid producing secondary waste, and produce a waste form with good water resistance and high boron loading rate, thereby greatly reducing the volume of the waste form produced and lowering the management cost.

The method of treating a liquid borate waste provided by the disclosure includes the following steps: modulating a raw liquid borate waste into a low-concentration liquid borate waste suitable for concentration; concentrating the low-concentration liquid borate waste into a high-concentration liquid borate waste; performing granulation of the high-concentration liquid borate waste with a granulating agent through solidification; preparing a hardenable slurry; preparing a waste form, including preparing a solidified waste form of borate granule (hereinafter referred to as a solidified waste form) and preparing a borate granule compressed block immobilized waste form (hereinafter referred to as an immobilized waste form).

The raw liquid waste is generally a low-concentration liquid borate waste containing hundreds, thousands or even tens of thousands of ppm of boron, which is obtained by preliminarily concentrating boron-containing waste water collected from ground or equipment. The raw liquid borate waste is modulated by a modulator to obtain the low-concentration liquid borate waste suitable for high concentration. After the low-concentration liquid borate waste is concentrated to prepare the high-concentration liquid borate waste containing polyborate with high polymerization degree (hereinafter referred to as the high-concentration liquid borate waste), when the high-concentration liquid borate waste and the granulating agent (i.e., solidifying agent) are granulated through a solidification reaction, no solidification retardation occurs, which thereby greatly increases the borate loading rate in the waste form produced and greatly reduces the volume of the finally produced waste form. Besides, since the high-concentration liquid borate waste is used for granulation to form hard borate granules, a waste form with high mechanical strength and high water resistance is formed by solidification of the borate granules and the hardenable slurry. Here, the procedure of mixing the borate granules and the hardenable slurry to prepare the monolithic waste form with high mechanical strength and high water resistance is called solidification, which is a conventional term with reference to the solidification of granule solid waste such as spent ion exchange resin, sludge and residue. This conventional term will also be used in the following description.

The above description is merely a general description of the technical solutions of the disclosure. In order to understand the technical means of the disclosure more clearly such that they can be implemented in accordance with the content of the specification, and to make the above and other objectives, features and advantages of the disclosure more comprehensible, a detailed description is given below in conjunction with preferred examples and accompanying drawings.

### BRIEF DESCRIPTION OF THE DRAWINGS

FIG. 1 is a schematic flowchart of a method of treating a liquid borate waste according to an example of the disclosure;

FIG. 2 is a schematic flowchart of a preparation of a solidified waste form package in the method according to an example of the disclosure; and

FIG. 3 is a schematic flowchart of a preparation of an immobilized waste form package in the method according to an example of the disclosure.

### DETAILED DESCRIPTION OF PREFERRED EMBODIMENTS

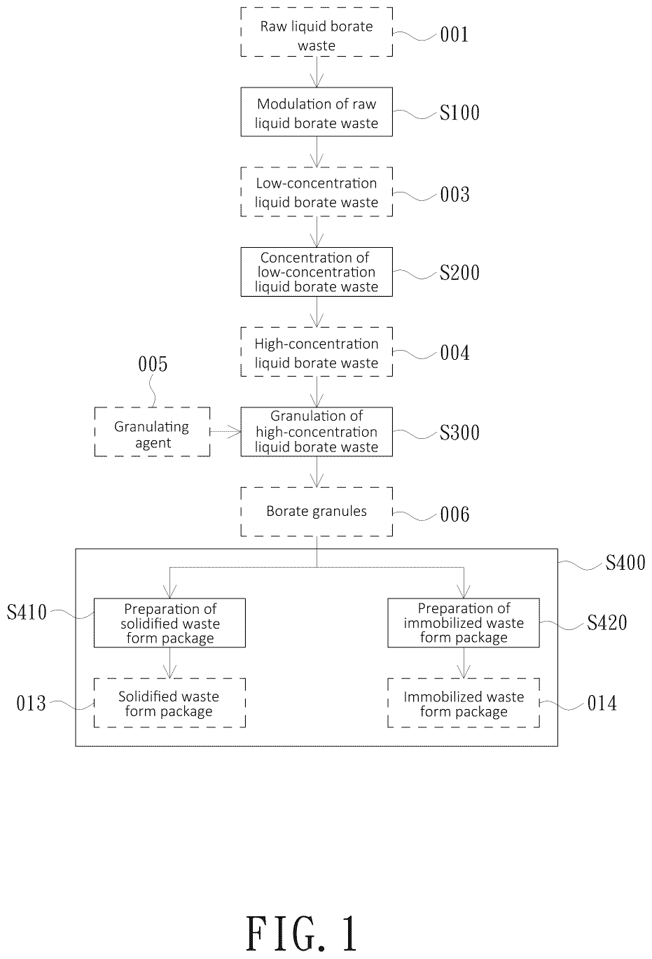

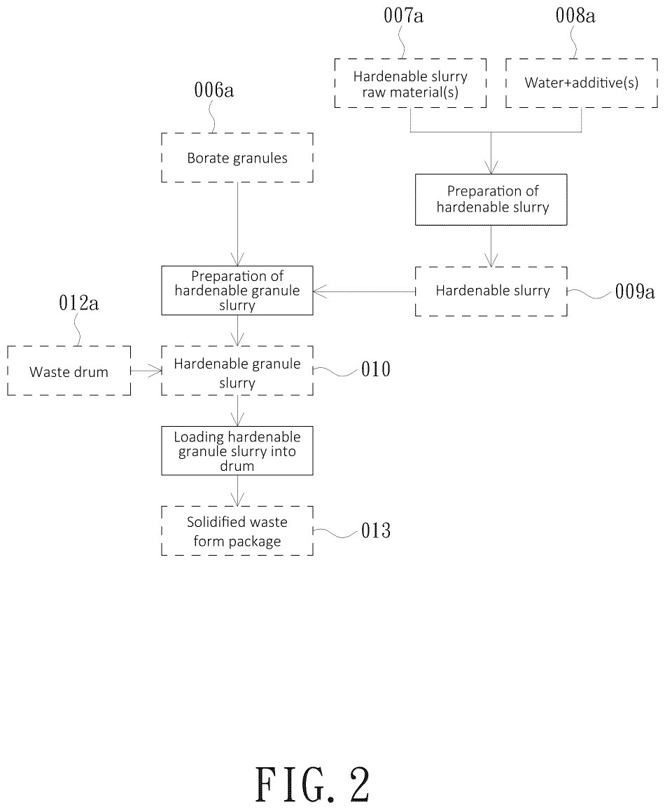

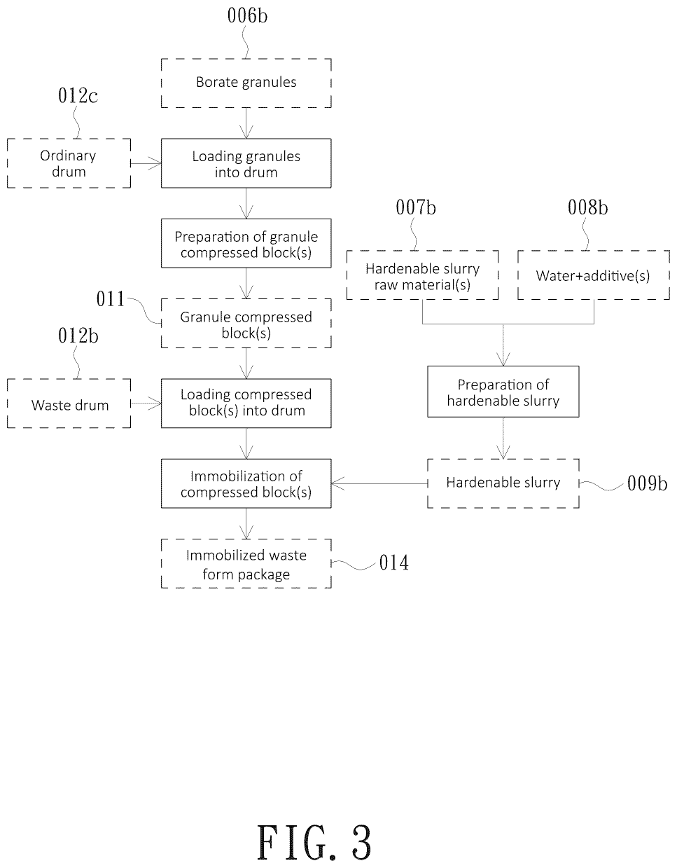

The disclosure provides a method of treating a liquid borate waste, as shown in FIG. 1, including: step S100: modulation of raw liquid borate waste: modulating an raw liquid borate waste 001 into a low-concentration liquid borate waste with satisfactory composition conditions for subsequent concentration (hereinafter referred to as a low-concentration liquid borate waste 003); step S200: concentration of low-concentration liquid borate waste: concentrating the low-concentration liquid borate waste to make a high-concentration liquid borate waste containing polyborate with high polymerization degree (hereinafter referred to as a high-concentration liquid borate waste 004); step S300: granulation of high-concentration liquid borate waste: making the high-concentration liquid borate waste into borate granules 006; and step S400: preparation of waste form package: preparing a hardenable slurry according to step S410 (as shown in FIG. 2), and solidifying the borate granules using the hardenable slurry to make a solidified waste form package, or preparing a hardenable slurry according to step S420 (as shown in FIG. 3), compressing the borate granules into a compressed block, loading the compressed block into a waste drum, and pouring the hardenable slurry to clad the compressed block so as to make an immobilized waste form package. The so-called “package” here refers to the assembly of the waste form and the waste drum (container). The detailed descriptions are as follows:

Step S100: modulation of raw liquid borate waste: The raw liquid borate waste 001 may be, for example, a sodium liquid borate waste with different concentrations from nuclear power plant. The disclosure can treat various liquid sodium borate wastes with different boron concentrations. The liquid sodium borate wastes from the nuclear power plant are generally subjected to preliminary evaporation. The original liquid borate waste entering the treatment procedure of the disclosure has a boron concentration of preferably 20,000 ppm, and more preferably 40,000 ppm, which can reduce the burdens of evaporation and concentration of the treatment system of the disclosure.

Step S100 further includes, for example, adjusting a sodium/boron mole ratio in the raw liquid sodium borate waste from the nuclear power station. Further, an adjustment solution may be added to the raw liquid sodium borate waste and then uniformly mixed. The adjustment solution may be, for example, a solution of sodium hydroxide, potassium hydroxide, lithium hydroxide, etc. When sodium hydroxide is used to adjust the liquid sodium borate waste, the sodium/boron mole ratio is preferably 0.25 to 0.35. Step S100 further includes adjusting a pH value of the raw liquid sodium borate waste, and the adjustment agent may be selected from boric acid, sulfuric acid, phosphoric acid, sodium hydroxide, calcium hydroxide, and barium hydroxide, or the like.

Step S200: concentration of low-concentration liquid borate waste: The liquid borate waste is concentrated generally by heating, and the device used is at least one of a stirring tank evaporator, a forced circulation evaporator, and a film evaporator, or a combination thereof as needed. The raw liquid sodium borate waste is modulated in step S100 to make the low-concentration liquid borate waste 003. In step S200, the low-concentration liquid borate waste 003 is concentrated to make a liquid polyborate waste containing polymerized sodium borate with high polymerization degree 004 (hereinafter referred to as the high-concentration liquid borate waste). The high-concentration liquid borate waste 004 has a boron concentration of preferably at least 100,000 ppm, more preferably more than 110,000 ppm and most preferably more than 120,000 ppm. However, the high-concentration liquid borate waste 004 is viscous and needs to be prevented from blocking or crystallization. A high boron concentration contributes to volume reduction and formation of granules with high mechanical strength and good performance in subsequent granulation. However, considering that a high viscosity of the high-concentration liquid borate waste will cause difficulties in transportation as well as crystallization and blocking, the boron concentration is preferably not higher than 130,000 ppm.

The sodium/boron mole ratio of the high-concentration liquid borate waste 004 prepared in step S200 is preferably kept at 0.25 to 0.35, and more preferably 0.28 to 0.32. The high-concentration liquid borate waste 004 needs to be stored at an appropriate temperature, which is preferably 40 to 80° C. A moderately high temperature is beneficial to preventing crystallization, but an excessively high temperature is not beneficial to the performance of the granules produced by granulation. Therefore, the high-concentration liquid borate waste may be stored at a moderately high temperature, and slightly cooled before granulation.

Step S300: granulation of high-concentration liquid borate waste: The granulating agent 005 may be prepared from a material selected from, for example, cementitious materials, pozzolanic materials, powders of oxides or hydroxides of alkaline earth metals having a valency of two or more, powders oxides or hydroxides of transition metals, powders of oxides or hydroxides of metalloids, or combinations thereof. The granulating agent 005 may also include powders of silicates, phosphates, carbonates, or complex salts of transition metals or metalloids, or combinations thereof. In addition to the granulating agent prepared from the above components, a suitable commercially-available sludge solidifying agent may also be used. The high-concentration liquid borate waste and the granulating agent form the borate granules through a solidification reaction. During the reaction, the liquid sodium polyborate with high polymerization degree and the granulating agent undergo the solidification reaction to obtain the solid borate granules with high strength. The composition and mechanical strength of the borate granules depend on the components of the granulating agent.

The granulator may be a conventional apparatus, or specially designed. Since the high-concentration liquid borate waste 004 in the examples of the disclosure is viscous and the semi-finished product of the granules in the steps has a high viscosity, the design of the granulator or the use of the materials should avoid or reduce adhesion of the aforementioned material or semi-finished product. For example, a drum-type granulator or a stirring tank-type granulator is used. The simple internal structure of the drum-type granulator helps in reducing the adhesion of the material or the semi-finished product. The stirring tank-type granulator is preferably a drum-type stirring tank or a planetary stirring tank with revolution and rotation functions and with rotational stirring blades, which helps in the formation of granules with high compactness and good mechanical strength.

The granulation in step S300 may include step S310: initial granulation and step S320: continuous granulation. The initial granulation in step S310 is performed in a case that there are no granules, which needs to place the granulating agent 005 in the granulator in advance, and the quantity of the granulating agent 005 should be enough to cover the stirring blades. After the feed of the granulating agent is completed, the stirring blades are started to make the granulating agent 005 roll and flow. Next, a preset quantity of high-concentration liquid borate waste 004 is slowly added in several times. After the high-concentration liquid borate waste 004 comes into contact with the rolling and flowing granulating agent 005 powder, the solidification reaction occurs, such that the borate granules 006 are formed. After the feed of the preset quantity of the high-concentration liquid borate waste is completed, the mixture is continuously stirred for 3 to 5 min, thereby completing the initial granulation. Generally speaking, step S310 only needs to be performed once. The granulation in step S320 is performed in a case that there have been granules in the granulator. The borate granules 006 obtained by the initial granulation or prepared previously may be placed in the granulator, and after the stirring blades are started, the granulating agent and the high-concentration liquid borate waste may be added alternately. Whether the granulating agent or the high-concentration liquid borate waste is added first may be selected at will. The ratio of the granulating agent and the high-concentration liquid borate waste added should be fixed to ensure the uniformity of properties of the granules. Step S320 may be repeated until a sufficient quantity of granules is prepared. For example, when the granules produced reach the capacity limit of the granulator, the granulation may be suspended, and part of the finished product of the granules may be taken out. Then, the granulation is continued.

A total weight of the granulating agent 005 used in step S300 is preferably less than a total weight of the high-concentration liquid borate waste 004. In step S310 or step S320 or throughout step S300, the ratio of the quantity of the granulating agent 005 to the quantity of the high-concentration liquid borate waste 004 may depend on the solidification reaction equivalent of the granulating agent 005, granulation operability, granule performance requirements, etc. In addition, in step S310, in order to avoid adhesion, it is generally preferred to use a higher proportion of the granulating agent 005. In step S320, a weight ratio of the granulating agent 005 to the high-concentration liquid borate waste 004 is substantially 0.2 to 0.6. The stirring speeds in step S310 and step S320 may depend on the granulator used (for example, the type of the granulator), the properties of the material and semi-finished product, and the size of the granules to be obtained. For example, fast stirring may be used to form smaller granules. Preferably, the borate granules 006 in the examples of the disclosure have a diameter of 2 to 5 mm. The granulator may further include, for example, a screen used to adjust the size of the discharged granules.

Step S400: preparation of waste form package: This step may include step S410: preparation of solidified waste form package and step S420: preparation of immobilized waste form package. As shown in FIG. 1 and FIG. 2, step S410 includes preparation of hardenable slurry, preparation of hardenable granule slurry and loading hardenable granule slurry into drum. The hardenable slurry 009a may be, for example, one of a cement slurry, a high-performance concrete slurry, a reactive powder concrete slurry, a gypsum slurry, and a high-fluidity slurry prepared from a pozzolanic material powder, and preferably has a high fluidity. The hardenable slurry is prepared from hardenable slurry raw material(s) 007a and an additive solution 008a prepared from water and additive(s). The preparation of the hardenable granule slurry 010 includes mixing the borate granules 006 (the borate granules used in step S410 are also denoted as 006a) and the hardenable slurry 009a such that the borate granules 006a are sufficiently embedded in the hardenable slurry 009a to form the hardenable granule slurry 010. The hardenable granule slurry 010 is poured into a container such as a waste drum 012a (e.g., a drum for loading the radioactive waste), and after the slurry is hardened, a solidified waste form containing borate granule is formed. Step S410 may further include curing the solid form to obtain mature and stable quality (detailed later). After the waste drum 012a containing the solidified granule waste form is sealed, the solidified waste form package 013 is obtained.

As shown in FIG. 3, step S420 includes loading borate granules into drum, preparation of compressed block(s) of granules, loading the compressed block(s) into a drum, preparation of a hardenable slurry, and pouring of the hardenable slurry for immobilization after loading the compressed block(s) into drum. The loading of the borate granules into the drum may use an ordinary container 012c. After loading the borate granules into the drum, the ordinary container 012c and the borate granules 006b may be compressed together to form the granule compressed block 011. The loading of the granule compressed block 011 into the drum uses a waste drum 012b. The preparation of the hardenable slurry 009b is the same as the preparation of the hardenable slurry 009a in step S410, which will not be repeated here. The immobilization of the granule compressed block 011 includes pouring the hardenable slurry 009b into the waste drum 012b containing the compressed block 011 such that the hardenable slurry 009b fills voids and clads the granule compressed block 011 to form the immobilized waste form of the granule compressed block. Step S420 may also include curing the immobilized waste form. The waste drum 012b containing the immobilized waste form of granule compressed block is sealed to obtain the immobilized waste form package 014.

The method of treating a liquid borate waste of the disclosure will be further illustrated by Examples I to VI.

### Example I

Step S100 to step S200: 980 g of deionized water is added to a 6 L glass beaker provided with electric stirring blades, and the electric stirring blades are started for stirring. 833 g of 99% sodium hydroxide and 4,340 g of 99% boric acid are slowly added to the water in the beaker in 4 times. The sodium hydroxide is added first, and then the boric acid is added. After the boric acid is completely dissolved, adjusting the volume of the solution to 4,200 ml with deionized water, and adjusting the temperature of the solution to 80° C. The analysis results show that the obtained solution has a boron concentration of 121,000 ppm (i.e., 12.1 wt %), which is equivalent to a boric acid concentration of 69.21 wt %. The sodium/boron mole ratio is 0.297. The obtained solution is used as a simulated high-concentration liquid borate waste.

Step S300 (S310 to S320): 90 parts of commercially available sludge solidifying agent STA-110 (product of EigenGreen International Inc.) and 10 parts of reagent-grade calcium hydroxide powder are mixed, ground by a grinder and passed through a 150-mesh screen, and the obtained powder is a granulating agent powder (granulating agent-A). The quantity of the granulating agent powder prepared may depend on the quantity of the high-concentration liquid borate waste.

Step S310: initial granulation: This step is performed by using a stirring tank-type granulator with planetary stirring blades. 1,640 g of the granulating agent-A powder is added to the above 20 L granulator, and the stirring device is started. Then, 2,350 g of the high-concentration liquid borate waste prepared in step S200 is slowly added dropwise into the stirred granulating agent powder in several times. Upon the completion of each addition, only after the high-concentration liquid borate waste is dispersed and form the granules together with the granulating agent, and the wet luster of the granules disappeared, could the next addition of the high-concentration liquid borate waste be started, thereby reducing mutual adhesion between the granules. After the addition of the high-concentration liquid borate waste is completed, stirring is performed for about another 5 min, thereby completing the preparation of the initial borate granules. The weight ratio of the granulating agent to the high-concentration liquid borate waste is 0.7 (with reference to Table 1). In the initial granulation in step S310, the required granulating agent is first added at one time, and then the high-concentration liquid borate waste is added in several times.

Step S320: continuous granulation: The borate granules obtained by the initial granulation are allowed to remain in the granulator, and the stirring is continued. Next, 200 g of the high-concentration liquid borate waste is slowly added dropwise into the granulator so as to be uniformly dispersed on the surfaces of the granules. Then, 80 g of the granulating agent is added onto the stirred granules. After the high-concentration liquid borate waste reacts with the granulating agent to obtain solid granules and the wet luster disappeared, a next addition of the high-concentration liquid borate waste is started. The high-concentration liquid borate waste and the granulating agent are alternately added for 14 times respectively, and total amounts of the high-concentration liquid borate waste and the granulating agent added are 2,800 g and 1,120 g respectively, thereby completing the granulation of the borate granules. In the continuous granulation in step S320, the granulating agent and the high-concentration liquid borate waste are alternately added according to a preset ratio in several times. The weight ratio of the granulating agent to the high-concentration liquid borate waste is 0.4. After the granulation is completed, the granules are stirred for another 5 min. Then, all the granules are taken out for the subsequent step.

As shown in Table 1, Example I uses a total of 2,760 g of the granulating agent and 5,150 g of the high-concentration liquid borate waste. The diameter of the borate granules is mainly distributed between 2 and 5 mm. The calculation results show that the granules have a boron content of 7.88 wt %, which is equivalent to a boric acid content of 5.06 wt %.

TABLE 1
Material conditions of Example I

| | | | Amount Used (g) | | |
|---|---|---|---|---|---|
| Material | | | Step | Step | |
| Name | Material Composition | | S310 | S320 | Total |
| Granulating | Granulating agent-A | | 1,640 | 1,120 | 2,760 |
| agent | | | | | |
| High- | Boron | Sodium/boron | 2,350 | 2,800 | 5,150 |
| concentration | concentration | mole | | | |
| liquid borate | (wt %) | ratio | | | |
| waste | 12.1 | 0.297 | | | |

| | | | |
|---|---|---|---|
| Total weight | 3,990 | 3,920 | 7,910 |
| Weight ratio of granulating agent/high- | 0.7 | 0.4 | 0.54 |
| concentration liquid borate waste | | | |

Step S400: A commercially available special solidifying agent ECOCRETE-FS (product of EigenGreen International Inc.) for nuclear waste treatment and quartz powder (with a particle size of 70 to 150 mesh) are used as raw materials of the hardenable slurry. 1,460 g of the solidifying agent (ECOCRETE-FS) and 1,350 g of the quartz powder are added to a 20 L planetary stirring machine, and stirring is started. 840 g of water is added, and the mixture is uniformly mixed to obtain 3,650 g of the hardenable slurry. Next, 3,500 g of the borate granules prepared in step S300 is added to the stirred hardenable slurry and uniformly mixed to obtain a hardenable granule slurry. Then, the granule slurry is poured into a cylindrical polyethylene plastic mold having an inner diameter of 5 cm and a height of 6 cm. After bubbles are removed by vibration and the surface is flattened, the granule slurry is cured in a constant temperature and humidity incubator with a temperature of 25° C. and a relative humidity of 95% for 28 days. The calculation results show that the weight of the hardenable slurry in Example I is 1.04 times that of the borate granules, and the obtained waste form has a boron content of 3.86 wt %, which is equivalent to a boric acid content of 22.07 wt %, and a specific gravity of 1.87. Therefore, the boron loading rate is 72.16 kg/m³, which is equivalent to a boric acid loading rate of 412.69 kg/m³.

After 28 d of curing of the hardenable granule slurry, demolding is performed, and the cylindrical solidified waste form with a diameter of 5 cm is cut to a height of 5 cm. The solidified waste form is tested for its compressive strength, weather resistance (freeze-thaw resistance) and water immersion resistance in accordance with the quality specifications for low-level radioactive waste bodies of R.O.C. Besides, the solidified waste form is also tested for its 9 m drop impact resistance. The results are shown in Table 2.

Table 2: Performance test results of solidified waste form sample of

Example I

| | | | Freeze- | Water |
|---|---|---|---|---|
| | Compressive | Impact | thaw | Immersion |
| Test Item | Strength | Resistance | Test | Resistance |
| Test Result | 10.3 mpa | Acceptable | 10.85 mpa | 11.2 mpa |

### Example II

Step S100 to step S200: A simulated high-concentration liquid borate waste is prepared according to the procedure and method in Example I. The boron concentration and the sodium/boron mole ratio of the high-concentration liquid borate waste are shown in Table 3.

Step S300: A commercially available sludge solidifying agent STA-110 (product of EigenGreen International Inc.) and a reagent-grade calcium hydroxide powder are mixed in a weight ratio of 1:1, and a granulating agent powder (granulating agent-B) is prepared according to the procedure in Example I.

Step S300 (S310 to S320): According to the procedure and method in Example I, granulation is performed in accordance with the material conditions in Table 3. The obtained borate granules have a boron content of 8.28 wt %, which is equivalent to a boric acid content of 47.36 wt %.

TABLE 3
Material conditions of Example II

| | | | Amount Used (g) | | |
|---|---|---|---|---|---|
| Material | | | Step | Step | |
| Name | Material Composition | | S310 | S320 | Total |
| Granulating | Granulating agent-B | | 1,200 | 1,500 | 2,700 |
| agent | | | | | |
| High- | Boron | Sodium/boron | 1,700 | 3,600 | 5,300 |
| concentration | concentration | mole | | | |
| liquid borate | (wt %) | ratio | | | |
| waste | 12.5 | 0.275 | | | |

| | | | |
|---|---|---|---|
| Total weight | 2,900 | 5,100 | 8,000 |
| Weight ratio of Granulating agent/high- | 0.71 | 0.42 | 0.51 |
| concentration liquid borate waste | | | |

Step S400: The hardenable slurry used is the same as in Example I. According to the procedure in Example I, a hardenable granule slurry is prepared in a hardenable slurry/borate granule weight ratio of 0.65. The prepared hardenable granule slurry has a boron content of 5.01 wt %, which is equivalent to a boric acid content of 28.64 wt %, and a specific gravity of 1.87. Therefore, the boron loading rate is 93.65 kg/m³, which is equivalent to a boric acid loading rate of 535.62 kg/m³.

The solidified waste form sample is prepared and subjected to performance testing according to the procedure in Example I. The results are shown in Table 4.

TABLE 4
Performance test results of solidified
waste form sample of Example II

| | | | Freeze- | Water |
|---|---|---|---|---|
| | Compressive | Impact | thaw | Immersion |
| Test Item | Strength | Resistance | Test | Resistance |
| Test Result | 13.14 mpa | Acceptable | 10.98 mpa | 13.8 mpa |

### Example III

Step S100 to step S200: A high-concentration liquid borate waste is prepared according to the procedure and method in Example I. The boron concentration and the sodium/boron mole ratio of the high-concentration liquid borate waste are shown in Table 5.

Step S300 (S310 to S320): According to the procedure in Example I, granulation is performed by using the granulating agent-B in accordance with the material conditions in Table 5. The obtained sodium borate granules have a boron content of 8.61 wt %, which is equivalent to a boric acid content of 49.26 wt %.

TABLE 5
Material conditions of Example III

| | | | Amount Used (g) | | |
|---|---|---|---|---|---|
| Material | | | Step | Step | |
| Name | Material Composition | | S310 | S320 | Total |
| Granulating | Granulating agent-B | | 1,200 | 1,500 | 2,700 |
| agent | | | | | |
| High- | Boron | Sodium/boron | 1,700 | 3,600 | 5,300 |
| concentration | concentration | mole | | | |
| liquid borate | (wt %) | ratio | | | |
| waste | 13 | 0.3 | | | |

| | | | |
|---|---|---|---|
| Total weight | 2,900 | 5,100 | 8,000 |
| Weight ratio of granulating agent/high- | 0.71 | 0.42 | 0.51 |
| concentration liquid borate waste | | | |

Step S400: The hardenable slurry used is the same as in Example I. According to the procedure in Example I, a hardenable granule slurry is prepared in a hardenable slurry/sodium borate granule weight ratio of 0.82. Then, the hardenable granule slurry is cured according the procedure in Example I. The prepared waste form has a boron content of 4.73 wt %, which is equivalent to a boric acid content of 27.07 wt %, and a specific gravity of 1.86. Therefore, the boron loading rate is 88.03 kg/m³, which is equivalent to a boric acid loading rate of 503.5 kg/m³.

The solidified waste form sample prepared is subjected to performance testing according to the procedure in Example I. The results are shown in Table 6.

TABLE 6
Performance test results of solidified
waste form sample of Example III

| | | | Freeze- | Water |
|---|---|---|---|---|
| | Compressive | Impact | thaw | Immersion |
| Test Item | Strength | Resistance | Test | Resistance |
| Test Result | 12.84 mpa | Acceptable | 11.5 mpa | 13.92 mpa |

### Example IV

Step S100 to step S200: A high-concentration liquid borate waste is prepared according to the procedure and method in Example I. The boron concentration and the sodium/boron mole ratio of the high-concentration liquid borate waste are shown in Table 7.

Step S300: 40 parts of commercially available sludge solidifying agent STA-110 (product of EigenGreen International Inc.) and 30 parts of barium hydroxide monohydrate are used to prepare a granulating agent powder (granulating agent-C) according to the procedure in Example I.

Step S300 (S310 to S320): According to the procedure and method in Example I, step S310 to step S320 are performed in accordance with the material conditions in Table 7. In step S320, the high-concentration liquid borate waste and the granulating agent are added alternately, and 200 g of the high-concentration liquid borate waste and 83 g of the granulating agent are added each time, where the high-concentration liquid borate waste are added before the granulating agent. After 50 times of addition of the high-concentration liquid borate waste and the granulating agent respectively, since the produced granules are close to the capacity limit of the granulator, the operation is suspended. After half the weight of sodium borate granules is taken out, granulation is continued according to the same method. After the high-concentration liquid borate waste and the granulating agent are added alternately for another 50 times respectively, the granulation of the liquid sodium borate waste is completed. In step S320, the high-concentration liquid borate waste and the granulating agent are respectively added for a total of 100 times, and the total amounts of the high-concentration liquid borate waste and the granulating agent added are respectively 20,000 g and 8,300 g. Next, all the sodium borate granules are collected and mixed for the subsequent step.

As shown in Table 7, the average weight ratio of the granulating agent to the high-concentration liquid borate waste used in Example IV is 0.454, and the diameter of the sodium borate granules is mainly distributed between 2 and 5 mm. The calculation results show that the granules have a boron content of 8.26 wt %, which is equivalent to a boric acid content of 47.25 wt %.

TABLE 7
Material conditions of Example IV

| | | | Amount Used (g) | | |
|---|---|---|---|---|---|
| Material | | | Step | Step | |
| Name | Material Composition | | S310 | S320 | Total |
| Granulating | Granulating agent-C | | 1,930 | 8,300 | 10,230 |
| agent | | | | | |
| High- | Boron | Sodium/boron | 2,540 | 20,000 | 22,540 |
| concentration | concentration | mole | | | |
| liquid borate | (wt %) | ratio | | | |
| waste | 12.01 | 0.3 | | | |

| | | | |
|---|---|---|---|
| Total weight | 4,470 | 28,300 | 32,770 |
| Weight ratio of granulating agent/high- | 0.76 | 0.415 | 0.454 |
| concentration liquid borate waste | | | |

Step S400: 40 parts of commercially available special solidifying agent ECOCRETE-RS (product of EigenGreen International Inc.) for nuclear waste treatment, 35 parts of quartz powder and 25 parts of water are used to prepare the hardenable slurry according to the procedure in Example I. Next, according to the procedure in Example I, a hardenable granule slurry is prepared in a hardenable slurry/sodium borate granule weight ratio of 1.12. The prepared hardenable granule slurry has a boron content of 3.89 wt %, which is equivalent to a boric acid content of 22.25 wt %, and a specific gravity of 1.87. Therefore, the boron loading rate is 72.74 kg/m³, which is equivalent to a boric acid loading rate of 416.04 kg/m³.

The solidified waste form sample is prepared according to the procedure in Example I, and subjected to performance testing after 28 d of curing. The results are shown in Table 8.

TABLE 8
Performance test results of solidified
waste form sample of Example IV

| | | | Freeze- | Water |
|---|---|---|---|---|
| | Compressive | Impact | thaw | Immersion |
| Test Item | Strength | Resistance | Test | Resistance |
| Test Result | 12.04 mpa | Acceptable | 16.5 mpa | 13.6 mpa |

### Example V

Step S100 to step S200: A high-concentration liquid borate waste is prepared according to the procedure and method in Example I. The boron concentration and the sodium/boron mole ratio of the high-concentration liquid borate waste are shown in Table 9.

Step S300: 52 parts of commercially available solidifying agent STA-110 (product of EigenGreen International Inc.), 36 parts of Portland Type II cement and 12 parts of reagent-grade magnesium hydroxide are used to prepare a granulating agent powder (granulating agent-D) according to the procedure in Example I.

Step S300 (S310 to S320): According to the procedure in Example IV, granulation is performed in accordance with the material conditions in Table 9. The average weight ratio of the granulating agent to the high-concentration liquid sodium borate waste is 0.363. The obtained sodium borate granules have a boron content of 8.81 wt %, which is equivalent to a boric acid content of 50.39 wt %. The diameter of the granules is mainly distributed between 2 and 5 mm.

TABLE 9
Material conditions of Example V

| | | | Amount Used (g) | | |
|---|---|---|---|---|---|
| Material | | | Step | Step | |
| Name | Material Composition | | S310 | S320 | Total |
| Granulating | Granulating agent-D | | 1,540 | 6,640 | 8,180 |
| agent | | | | | |
| High- | Boron | Sodium/boron | 2,540 | 20,000 | 22,540 |
| concentration | concentration | mole | | | |
| liquid borate | (wt %) | ratio | | | |
| waste | 12.01 | 0.3 | | | |

| | | | |
|---|---|---|---|
| Total weight | 4,080 | 26,640 | 30,720 |
| Weight ratio of granulating agent/high- | 0.606 | 0.332 | 0.262 |
| concentration liquid borate waste | | | |

Step S400: The hardenable slurry used is the same as in Example IV. According to the procedure in Example IV, a hardenable granule slurry is prepared in a hardenable slurry/sodium borate granule weight ratio of 1. The prepared hardenable granule slurry has a boron content of 4.41 wt %, which is equivalent to a boric acid content of 25.2 wt %, and a specific gravity of 1.88. Therefore, the boron loading rate is 82.79 kg/m³, which is equivalent to a boric acid loading rate of 473.5 kg/m³.

The preparation, curing, and performance testing of the solidified waste form sample are performed according to the procedure in Example I. The results are shown in Table 10.

TABLE 10
Performance test results of solidified
waste form sample of Example V

| | | | Freeze- | Water |
|---|---|---|---|---|
| | Compressive | Impact | thaw | Immersion |
| Test Item | Strength | Resistance | Test | Resistance |
| Test Result | 11.38 mpa | Acceptable | 12.55 mpa | 11.21 mpa |

### Example VI

Step S100 to step S200: A high-concentration liquid borate waste is prepared according to the procedure and method in Example I. The boron concentration and the sodium/boron mole ratio of the high-concentration liquid borate waste are shown in Table 11. In this example, in order to test the leaching resistance of the solidified waste form, 200 ppm cobalt nitrate hexahydrate and 100 ppm cesium nitrate are added to the high-concentration liquid borate waste to serve as an experimental group. In the control group, no cobalt nitrate hexahydrate and no cesium nitrate are added.

Step S300 (S310 to S320): The granulating agent-A is used. According to the procedure in Example I, step S300 is performed in accordance with the material conditions in Table 11. The experimental group and the control group are performed separately. The obtained sodium borate granules have a boron content of 3.57 wt %, which is equivalent to a boric acid content of 20.39 wt %.

TABLE 11
Material conditions of Example VI

| | | | | | Amount Used (g) | | |
|---|---|---|---|---|---|---|---|
| | | | | | Step | Step | |
| Material Name | Material Composition | | | | S310 | S320 | Total |
| Granulating agent | Granulating agent-A | | | | 1,350 | 1,732 | 3.082 |
| High-concentration | Boron | Cobalt nitrate | Cesium nitrate | Sodium/boron | 1,630 | 3,475 | 5,105 |
| liquid borate waste | concentration | hexahydrate | concentration | mole ratio | | | |
| (experimental group) | (wt %) | concentration | (ppm) | | | | |
| | | (ppm) | | | | | |
| | 12.002 | 200 | 100 | 0.3 | | | |

| | | | |
|---|---|---|---|
| Total weight | 2,980 | 5,207 | 8,187 |
| Weight ratio of granulating agent/high-concentration liquid borate waste | 0.828 | 0.498 | 0.60 |

Step S400: 70 parts of commercially available special solidifying agent ECOCRETE-RS (product of EigenGreen International Inc.) for nuclear waste treatment and 30 parts of water are used to prepare the hardenable slurry according to the procedure in Example I. Next, according to the procedure in Example I, a hardenable granule slurry is prepared in a hardenable slurry/sodium borate granule weight ratio of 1.10. The experimental group and the control group are performed separately. The prepared hardenable granule slurry has a boron content of 3.57 wt %, which is equivalent to a boric acid content of 20.39 wt %, and a specific gravity of 1.86. Therefore, the boron loading rate is 66.32 kg/m³, which is equivalent to a boric acid loading rate of 379.31 kg/m³.

The preparation, curing, and performance testing of the solidified waste form samples in the experimental group and the control group are respectively performed according to the procedure in Example I, and in the leaching resistance testing, an inductively coupled plasma-optical emission spectrometer (ICP-OES) is used to quantify cobalt and cesium in the leaching solutions. The performance test results of the experimental group are shown in Table 12, and all the results meet the requirements of performance standards. In the leaching solution of the control group, presence of cobalt and cesium is not detected.

TABLE 12
Performance test result of solidified waste form sample of Example VI

| | | | | | Leaching Resistance | | |
|---|---|---|---|---|---|---|---|
| | | | | | | | Cumulative |
| | | | | Water | Leaching | | leaching |
| Test | Compressive | Impact | Freeze- | Immersion | rate on | | fraction on |
| Item | Strength | Resistance | thaw Test | Resistance | Day 42 | | Day 42 |
| Test | 12.0 mpa | Acceptable | 14.2 mpa | 23.2 mpa | Cobalt | 8.499E−06 | 2.492E−03 |
| Result | | | | | Cesium | 2.404E−03 | 0.226 |

In Examples I to VI, the sodium borate granules are made into the solidified waste form of borate granule according to step S410, but as mentioned above, the sodium borate granules may also be made into compressed blocks to make immobilized waste form according to step S420. However, different from the solidified waste form, the performance specifications of the immobilized waste form generally require a stable outer sealing layer with a certain thickness. The examples of the disclosure have fully proved that various hardenable slurries prepared can form a hardened form with good performance, so that the hardenable slurries are competent to produce the immobilized waste form with good performance, when being poured to clad and immobilize the compressed block(s).

Based on the above, the method of the disclosure can prepare the waste form with good performance and high boron loading rate, thereby reducing the final volume of the waste. Furthermore, compared with the conventional methods, the granulation method of the disclosure is simple and easy to implement, does not produce any secondary liquid waste, and can greatly reduce the radioactive waste management cost.

The above description merely illustrates preferred examples of the disclosure, and is not a limitation to the disclosure in any form. Although the disclosure has been disclosed as above in the preferred examples, it is not intended to limit the disclosure. Any person skilled in the art can use the method and technical content disclosed above to make some changes or modifications into equivalent examples with equivalent variations without departing from the scope of the technical solution of the disclosure. Any simple changes, equivalent variations and modifications made to the above examples based on the technical essence of the disclosure without departing from the content of the technical solution of the disclosure shall fall within the scope of the technical solution of the disclosure.

What is claimed is:

1. A method of treating a liquid sodium borate waste to produce a monolithic solid with high strength and high water immersion resistance, comprising:
making a raw liquid borate waste into a liquid waste containing polymerized sodium borate with high polymerization degree;
reacting the liquid waste containing polymerized sodium borate with high polymerization degree with a granulating agent and preparing a plurality of borate granules; and
preparing a solidified waste form of borate granule and an immobilized waste form of borate granule compressed block respectively by either (1) or (2);
(1) mixing the plurality of borate granules and a hardenable slurry to form a hardenable granule slurry, and curing the hardenable granule slurry to form a solidified waste form of borate granule; and
(2) compressing the borate granules into a compressed block, pouring a hardenable slurry to clad the compressed block, and curing the hardenable slurry to form an immobilized waste form of borate granule compressed block(s).

2. The method according to claim 1, wherein the step of preparing the borate granules comprises the following steps:
modulating the raw liquid borate waste by using sodium hydroxide, boric acid or a combination thereof such that a sodium/boron mole ratio of the liquid borate waste is 0.25 to 0.35;
concentrating the liquid borate waste to form a liquid polyborate waste with high polymerization degree having a boron concentration of more than 100,000 ppm; and
feeding the liquid polyborate waste and a granulating agent powder into a granulator, and performing a solidification reaction to form the plurality of solid borate granules.

3. The method according to claim 1, wherein the step of preparing the solidified waste form of borate granule further comprises the following steps:
preparing the hardenable slurry, and mixing the plurality of borate granules and the hardenable slurry to form the hardenable granule slurry; and
loading the hardenable granule slurry into a waste drum, and hardening the hardenable granule slurry to form a solidified waste form package of borate granule.

4. The method according to claim 1, wherein the step of preparing the immobilized waste form of borate granule further comprises the following steps:
adding the plurality of borate granules into a drum, and compressing the borate granules and the drum into a compressed block;
loading the compressed block into a waste drum; and
preparing the hardenable slurry, pouring the hardenable slurry to clad the compressed block in the waste drum and fill voids in the drum, and hardening the hardenable slurry to form a immobilized waste form package of borate granule compressed block.

5. The method according to claim 2, wherein the step of modulating the raw liquid borate waste further comprises adjusting the pH value of the raw liquid borate waste by using at least one of the following compounds: boric acid, sulfuric acid, phosphoric acid and sodium hydroxide.

6. The method according to claim 2, wherein the granulating agent is prepared from at least one of the following materials: cementitious materials, pozzolanic materials, powders of oxides or hydroxides of alkaline earth metals having a valency of two or more, powders of oxides or hydroxides of transition metals, powders of oxides or hydroxides of metalloids, powders of silicates, phosphates, carbonates or complex salts, or a combination thereof.

7. The method according to claim 1, wherein the hardenable slurry is an aqueous slurry selected from a cement slurry, a high-performance concrete slurry, a reactive powder concrete slurry, a gypsum slurry, and a high-fluidity slurry prepared from a pozzolanic material powder.

8. The method according to claim 2, wherein the granulator is selected from one of a drum-type stirring tank and a planetary stirring tank with revolution and rotation functions.

9. The method according to claim 2, wherein the total weight of the liquid polyborate waste used during the granulation is greater than the total weight of the granulating agent.
